(19) United States
(12) Patent Application Publication
(10) Pub. No.: US 2008/0071395 A1
(43) Pub. Date: Mar. 20, 2008

(54) MODEL PREDICTIVE CONTROL WITH STOCHASTIC OUTPUT LIMIT HANDLING

(75) Inventor: Daniel Pachner, Prague (CZ)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc., Morristown, NJ (US)

(21) Appl. No.: 11/465,756

(22) Filed: Aug. 18, 2006

(51) Int. Cl. G05B 13/02

(52) U.S. Cl. 700/34

(57) ABSTRACT

Cautious Model Predictive Control controllers and methods for stochastically handling output limits used in the optimization of control systems are disclosed. An illustrative method can include the steps of providing one or more modeled parameters and process variables to a predictor for predicting future expectations and variances along a control horizon, stochastically determining the probability of a constraint violation, optimizing a control function of the control system to produce an optimized solution, and offsetting the optimized solution based at least in part on the probability of a constraint violation.

### FIELD

The present invention relates generally to the field of control systems and methods. More specifically, the present invention pertains to Model Predictive Control (MPC) controllers and methods for stochastically handling output limits used in the optimization of control systems.

### BACKGROUND

Model Predictive Control (MPC) refers to a class of computer algorithms capable of computing sequences of manipulated variable adjustments, or control moves, in order to optimize the future behavior of a control system. Computerized control systems employing MPC-based techniques are particularly well-suited for controlling complex processes where multivariable optimization is often necessary. Some control systems that can be controlled with MPC-based techniques can include combustion systems, engine control, power plants, chemical processing plants, distillation equipment, petroleum refineries, fluid beds, and the like. Typically, such systems will have multiple parameters or variables which require continuous or near continuous real-time adjustment or tuning in order to compute control moves as an optimization solution for minimizing errors subject to constraints. In many process control systems, for example, several instruments, control devices, and communication systems are often used to monitor and manipulate control elements such as valves and switches to maintain one or more process variable values (e.g. temperature, pressure, etc.) at selected target values. In some cases, the MPC-based controller will often be provided as part of a multi-level hierarchy of control functions used to control the system in a particular manner.

The MPC-based controller will typically include an optimization module used to define a solution to the control problem at steady state, and a dynamic control module used to define how to move the process to the steady state optimum without violating any imposed constraints. Generally speaking, MPC-based controllers are configured to handle three types of variables; namely, controlled process variables, manipulated variables, and disturbance or feed-forward variables. Controlled process variables are those variables that the MPC controller seeks to maintain within the imposed lower and/or upper constraints. Manipulated variables are those variables that the controller can vary to achieve a desired control objective while also maintaining all of the controlled variables within their constraints. Disturbance or feed-forward variables, in turn, are those variables which affect the control system but which are not controlled.

Optimization strategies for many control systems employing MPC-based controllers are often limited to the type of output constraints imposed on the optimization solution. Typically, process output constraints can be respected by conventional MPC-based controllers if formulated by inequality constraints. Currently, when an optimizer determines that there is no feasible optimization solution which keeps all of the process control outputs or inputs within previously established constraints or limits, the optimizer will usually relax one or more of the constraints, or will impose a “slack” variable to prioritize the variables in order to find an acceptable solution. Such approaches do not often work for process outputs affected by uncertain parameters or random disturbances, and are not effective in dynamic situations where steady state control is unlikely. In some cases, the control objective may be unfeasible if the constraints are contradictory, which can sometimes result from the temporary effects of disturbances on the control system.

### SUMMARY

The present invention pertains to Model Predictive Control (MPC) controllers and methods for stochastically handling output limits for control systems. An illustrative MPC controller for cautiously controlling a control system can include a means for predicting future expectations and variances based on one or more modeled parameters of the control system, a means for stochastically determining the probability of a constraint violation occurring in the control system, and a means for optimizing a control function of the control system and producing an optimized solution based at least on the probability of a constraint violation. In some embodiments, the means for stochastically determining the probabilities of a constraint violation occurring can include a linear programming algorithm adapted to minimize a risk function representing the total risk associated with all constraints on the control horizon. Optimization of the control function to produce an optimized solution can be performed using a quadratic programming algorithm or the like.

An illustrative method of stochastically handling output limits of a control system may begin with the step of providing one or more modeled parameters and process variables to a predictor for predicting future expectations and variations along a control horizon of the control system. Using the predicted expectations and variations, the probability of a constraint violation can then be determined stochastically by minimizing a risk function. A primary control function of the control system can then be optimized to produce an optimized solution, which can then be offset based at least in part on the probability of a constraint violation. In some methods, for example, the optimized solution can be offset to prevent constraint violations using weighting parameters for one or more process constraints of the control system, and/or using a constraint violation risk increase parameter. By stochastically determining the likelihood of a constraint violation and then offsetting the optimization solution based on the risk, the cautious MPC controller is capable of dynamically controlling multiple volatile processes of the control system that are uncertain.

### BRIEF DESCRIPTION OF THE DRAWINGS

FIG. 1 is a block diagram showing an illustrative control system employing a cautious MPC controller in accordance with an exemplary embodiment;

FIG. 2 is a graph showing the probability of a constraint violation;

FIG. 3 is a graph showing a standard probability function and its chord approximation for the illustrative cautious MPC controller of FIG. 1;

FIG. 4 is a graph showing an illustrative control solution for a cooling system using both the cautious MPC module of FIG. 1 and a conventional MPC-based controller using hard constraints;

FIG. 5 is a block diagram showing an illustrative method of cautiously controlling a process using a cautious MPC controller;

FIG. 6 is a block diagram showing an illustrative method of cautiously controlling coal powder combustion in a power and heat plant boiler using a cautious MPC controller;

FIG. 7A is a graph representing a number of illustrative process variables used in the illustrative method of FIG. 6 over several sampling periods;

FIG. 7B is a graph representing a number of illustrative manipulated variables used in the illustrative method of FIG. 6 over the sampling periods in FIG. 7A;

FIG. 7C is a graph representing a number of illustrative auxiliary process variables used in the illustrative method of FIG. 6 over the sampling periods in FIG. 7A; and

FIG. 8 is a graph showing the illustrative combustion control problem of FIG. 6 in steady state.

### DETAILED DESCRIPTION

The following description should be read with reference to the drawings, in which like elements in different drawings are numbered in like fashion. The drawings, which are not necessarily to scale, depict selected embodiments and are not intended to limit the scope of the invention. Although examples of systems and methods are illustrated in the various views, those skilled in the art will recognize that many of the examples provided have suitable alternatives that can be utilized. Moreover, while the various views are described specifically with respect to several illustrative control systems, it should be understood that the controllers and methods described herein could be applied to the control of other types of systems, if desired.

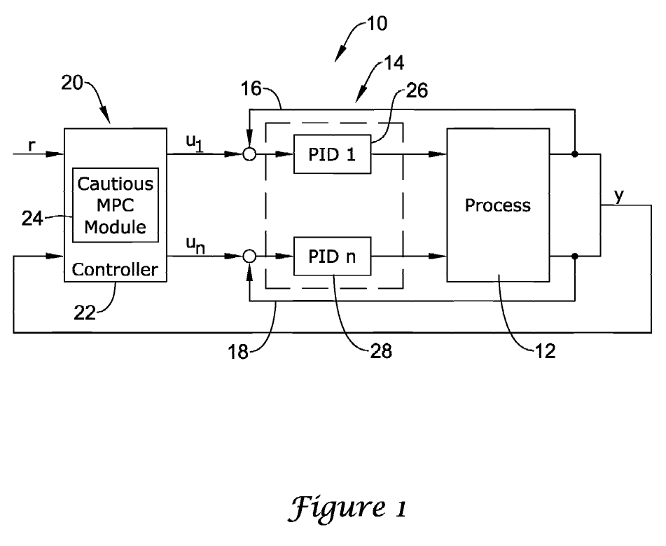

Referring now to FIG. 1, an illustrative control system 10 employing a cautious MPC controller in accordance with an exemplary embodiment will now be described. Control system 10, illustratively a two-level hierarchical control system for use in controlling one or more desired processes 12, can include a lower-level 14 of system control that can be used to stabilize one or more individual base control loops 16,18 and compensate for process parameter variations, and a second, higher-level 20 of system control that can be used to provide model-based predictive control over the individual base control loops 16,18, directly over the process 12, or a combination of both. As is discussed in greater detail below, a multiple-input multiple-output (MIMO)-type controller 22 including a Cautious Model-based Predictive Control (CMPC) module 24 can be provided at the higher-level 20 of system control in order to modify various control actions based on possible risks resulting from model mismatch and/or by unknown future disturbances on the control system 10.

The lower-level 14 of system control can include a number of linear and/or non-linear controllers 26,28 that can be tasked to enhance the overall robustness of the process 12 by controlling one or more control parameters. In some embodiments, for example, the lower-level 14 system controllers 26,28 can each include a linear controller such as proportional-integral-derivative (PID)-type controller, although other types of linear and/or non-linear controllers can be employed. Each PID controller can be configured to operate on a single associated control loop 16,18, typically with one process variable or one control variable of the process 12 being controlled. An example of a single-input, single-output control loop 16,18 that can be controlled by a PID controller may include a mass flow process variable for adjusting the valve-opening angle for a process 12 employing an adjustable valve. In such configuration, the PID controller operates on the mass flow process variable via feedback (i.e. “y”) received from the process 12 and from control signals (“u₁” . . . “uₙ”) received from the higher-level 20 of system control in order to compute the valve-opening angle of the valve, which is the control variable for the process 12. Although each controller 26,28 is typically tasked to control a single control loop 16,18, controllers 26,28 adapted to control two or more process parameters using two or more manipulated variables simultaneously are also possible in some cases, particularly where the process variables being controlled are well defined.

Although the lower-level 14 system controllers 26,28 are each capable of controlling one, and in some cases, multiple control loops 16,18, such controllers 26,28 are usually unable to address sophisticated problems involving multiple process variable interactions. In some applications, for example, a number of mutually correlated process variables may need to be controlled, which may depend from a number of manipulated control variables. In such situation, the lower-level 14 of system control can be superimposed with the higher-level 20 of system control such that the lower-level 14 operates on the single control loop 16,18 interactions while the higher-level 20 is concerned with optimizing multiple interactions generically over a control horizon, either directly based on controlled process variables “y” from the process 12 or based on the signals from the lower-level 14 of system control. The set-point values (“r”) for use by the CMPC module 24, in turn, can be supplied by operators and/or can be calculated using a third level control system, if desired, which in some embodiments can include a steady state plant optimizer. An example of a controller 22 employed at the higher-level 20 of system control can include a multiple-input, multiple-output (MIMO) controller, which can be configured to run the CMPC module 24 for stochastically handling the output limits of the control system, as discussed herein.

In some embodiments, the CMPC module 24 can be based on a linear, dynamic, stochastic, time-invariant, and discrete (i.e. sampled) model. The term “cautious” is used herein to describe control behavior of the CMPC module 24 that modifies control actions due to possible risks caused by mismatch of the model describing the process 12 and/or due to unknown future disturbances. Typically, the process model will comprise a linear stochastic model disturbed by multivariate white noise. It should be understood, however, that the process model or portions thereof may be non-linear as well. As denoted herein, boldface letters shall indicate a column vector whereas boldface letters with a prime (e.g. “u′(t)”) will denote row vectors or a matrix transposition. The controlled process variables, in turn, are denoted herein by “y(t)”, where “t” represents the consecutive number of a time sampling period.

An illustrative process model for use by the CMPC module 24 will now be described. At any instant t, the higher-level 20 system controller 22 optimizes the controls along the control horizon from the sample time t=1 until time t+H, where “H” represents the number of sampling periods of a finite control horizon to be optimized. The future controls concatenated to a single column vector can be expressed as follows:

u_{t+H}^{t+1}=(u′(t+1)u′(t+2) . . . u′(t+H)′. (1)

In general, the CMPC module 24 optimizes the future controls expressed in (1) above during the time interval (t, t+1), in which the process data collection, algorithm computations, and the result communications must be performed. At time t+1, the future controls are computed and a first value is sent to the lower-level 14 of system control and/or directly to the process 12. This periodic optimization on a finite future interval is then repeated for every sampling period, providing receding horizon control over the control system.

The process model provided to the control system 10 can be used to evaluate the following conditional expectations “E” and conditional variances “σ²” for i≦≦H:

E{y(t+m)|d(t),uₜ₊ₘ^{t+1}},σ²{y(t+m)|d(t),uₜ₊ₘ^{t+1}}. (2)

The expectations “E” in (2) above are conditioned by future controls as well as past historical process data “d”, both on the input and output sides of the control system 10. The historic data can be represented by the system state “x” or by sufficient statistics describing the system state “x”. To simplify notations in the equations, the expectation conditions on “d” are conditioned by all process history, which can be represented by a Kalman filter state estimate and its covariance matrix as follows:

d(t)={uₜ^{-∞},yₜ^{-∞}}. (3)

The linear dynamic models typically define the one step forward predictions in which subsequent predictions can be evaluated by means of a predictor such as a Kalman filter or the like. In some embodiments, the predictor can be configured to evaluate both future expectations and future variances for the linear model, as needed. In such case, the CMPC module 24 usually requires that the future prediction variances not depend on the future manipulated variables. A neutrality condition can then be used for determining the variances σ², which for a linear system, can be satisfied by the following:

σ²{y(t+m)|d(t),uₜ₊ₘ^{t+1}}=σ²{y(t+m)}, (4)

where “σ²” represents the expected standard deviation of the expectations “E”. The primary control objective for the CMPC module 24 can then be solved using a quadratic function minimization “J” in a positive, semi-definite quadratic form of the future controls and the future controlled process expectation variables. In such case, the primary control objective can be rewritten as a function of the initial state and the future control values substituting for the expectations, which can be expressed as follows:

J_{y}(u_{t+H}^{t+1},E{y_{t+H}^{t+1}})=J_{d}(d(t),u_{t+H}^{t+1}). (5)

For a conventional control problem using standard MPC algorithmic techniques, the MPC solution would attempt to minimize the following conditions under a set of constraints expressed as a set of linear inequalities:

Aᵤu_{t+H}^{t+1}≦bᵤA_{y}E{y_{t+H}^{t+1}}≦b_{y}. (6)

In the above expression (6), the future controlled expectation values in a conventional MPC-based technique would normally be substituted using the model equation governing the process. In such configuration, the controlled variables themselves are not constrained, but instead their value expectations. Using the value expectations instead of their uncertain and partially predictable controlled values, the conventional MPC-based technique is thus not able to account for prediction uncertainty in the process.

In contrast to a conventional MPC-based technique, the CMPC module 24 strives to minimize the primary control objective under the same constraints valid for the uncertain “y” values, based on the following expression:

Aᵤu_{t+H}^{t+1}≦bᵤA_{y}y_{t+H}^{t+1}≦b_{y}. (7)

Thus, as can be seen above, the CMPC module 24 substitutes for the expectations using the process model. For sake of clarity and not limitation, the controlled variable constraints can be assumed to be box constraints, which can define the minimum and maximum coordinate values for the “y” vector. The lower constrained coordinates can be denoted generally by the subscript set “i” whereas the upper constrained coordinates can be denoted generally by the subset script “j”. Based on this nomenclature, the box constraints can be expressed using the lower constraint values and upper constraint values as follows:

yⱼ≦ y̅ⱼyᵢ≧yᵢ∀i,j. (8)

While the above expression (8) accounts for both lower and upper constraint values, it should be understood, however, that not all controlled variables will need to be lower and/or upper constrained. In some embodiments, for example, only lower constraint values or upper constraint values may be needed.

To achieve cautious behavior, the CMPC module 24 considers the probabilities of constraint violation as a risk function, which is a weighted sum of all respective risks with all output constraints and all time instants within the control horizon accounted for. The lower constraints violation probability can be defined generally by the integral:

Pᵢ(t+m|d(t),u_{t+H}^{t+1})=∫_{-∞}^{y}^{ᵢ}p(yᵢ(t+m)|d(t),u_{t+H}^{t+1})dyᵢ. (9)

In analogous fashion, the upper constraints violation probability can be defined generally by the integral:

P̅ⱼ(t+m|d(t),u_{t+H}^{t+1})=∫ _{y̅}_{ⱼ}^{∞}p(yⱼ(t+m)|d(t),u_{t+H}^{t+1})dyⱼ. (10)

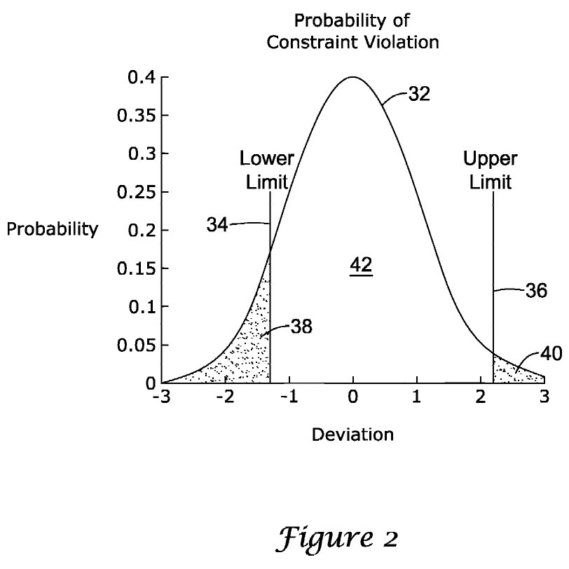

FIG. 2 is a graph showing the probability of a constraint violation based on equations (9) and (10) above. As shown in FIG. 2, the probability of a constraint violation occurring can be represented generally by the shaded areas bounded by the output prediction probability distribution curve 32 and the lower and upper constraint probability limits 34,36. The lower constraint violation probability of equation (9) above can be represented, for example, by the bounded area 38 below the output prediction probability distribution curve 32 and to the left of the lower constraint violation probability limit 34. The upper constraint violation probability of equation (10) above, in turn, can be represented by the bounded area 40 below the output prediction probability distribution curve 32 and to the right of the upper constraint violation probability limit 36. The probability that a constraint violation will not occur, in turn, can be represented by the bounded area 42 below the output prediction probability distribution curve 32 and between the upper and lower limits 34,36.

In use, the CMPC module 24 can be configured to shift the probability distribution functions so that the weighted sum of the shaded areas 38,40 would normally be minimized. The probability distribution functions can be shifted, for example, using the process controls described herein as a starting point. For a linear model, the above probabilities of a constraint limit violation can be expressed in terms of the standard univariate cumulative probability distribution function “Φ” as follows:

$$Φ ( z ) = \frac{1}{\sqrt{2 π}} {\int }_{- ∞}^{z} exp ( - \frac{1}{2} {ζ}^{2} ) d ζ ; \qquad ( 11 )$$

where “z” represents the transformation variables for the constraints. The standard univariate cumulative probability function “Φ” expressed in equation (11) above can then be combined with the expectations “E” and conditional variances “σ²” contained in (2) above in order to determine the probability that a constraint violation within the shaded areas 38,40 will likely occur. The probabilities of constraint violations can be expressed using the following transformations “z” for the lower constraints “i”:

$${\underline{z}}_{i} ( t + m , d ( t ) , {u}_{t + H}^{t + 1} ) = \frac{ {\underline{y}}_{i} - E \{ {y}_{i} ( t + m ) \vert x ( t ) , {u}_{t + H}^{t + 1} \}}{σ \{ {y}_{i} ( t + m ) \}} . \qquad ( 12 )$$

### The transformations “z” for the upper constraints “j” can be accomplished in an analogous manner.

Using the equality of the integrals in equation (13) below, the standard probability distribution function “Φ” can be applied to the transformed variables “z” as follows:

$$\frac{1}{\sqrt{2 π {σ}^{2}}} {\int }_{- ∞}^{y} exp ( - \frac{1}{2} \frac{{( ζ - μ )}^{2}}{{σ}^{2}} ) d ζ = \frac{1}{\sqrt{2 π}} {\int }_{- ∞}^{\frac{y - μ}{σ}} exp ( - \frac{1}{2} {ζ}^{2} ) d ζ . \qquad ( 13 )$$

Based on function (13) above, the constraint violation probability “P” for “i” and “j” can then be expressed in closed form in terms of the standard univariate cumulative probability function “Φ” as follows:

P̅ⱼ=Φ( z̅ⱼ)Pᵢ=1−Φ(zᵢ)=Φ(−zᵢ). (14)

Based on the constraint violation probability “P”, the CMPC module 24 can then be configured to define a risk function “R” representing the total risk associated with all constraints on the control horizon, and the expected losses associated with constraint violations caused by a particular series of controls. The risk function “R” may represent, for example, the weighted sum of all probabilities evaluated for a fixed initial state and fixed future control values, which can be expressed generally as:

$$R ( d ( t ) , {u}_{t + H}^{t + 1} ) = {\sum }_{m = 1}^{H} ( {\sum }_{i} {\underline{w}}_{i} {\underline{P}}_{i} ( t + m \vert d ( t ) , {u}_{t + H}^{t + 1} ) + {\sum }_{j} {\overline{w}}_{j} {\overline{P}}_{j} ( t + m \vert d ( t ) , {u}_{t + H}^{t + 1} ) ) . \qquad ( 15 )$$

In the above equation (15), the positive weight “w” term reflects the relative importance of each process constraint. The positive weights “w”, for example, may be understood to approximate the economic figures, spoilt batch processes, etc. of the control system to be controlled.

Once the risk function “R” has been used to define a proposed cautious optimization problem solution to be solved, the CMPC module 24 may then translate the primary control objective “J” minimization under the constraints into an optimization problem as follows:

$${min}_{u} {J}_{x} ( d ( t ) , {u}_{t + H}^{t + 1} ) , {A}_{u} ( {u}_{t + H}^{t + 1} ) \leq {b}_{u} , R ( d ( t ) , {u}_{t + H}^{t + 1} ) \leq {R}^{*} ( d ( t ) ) ( 1 + ɛ ) ; \qquad ( 16 )$$

where “J” is the function to be minimized, “u” represents the future manipulated variables subject to the constraints, “R*” is a minimum risk function, and “ε” is a user-supplied allowable constraints violation risk increase parameter. Thus, instead of constraining the future minimum values “y” of the process, as is typical in many conventional MPC-based controllers, the cautious MPC module 24, in contrast, seeks to constrain the future risk value “R”.

The minimum risk value “R*” can be defined as the minimum risk “R” achievable by the process starting from the current initial state, which can be expressed generally as:

$${R}^{*} ( d ( t ) ) = {min}_{u} R ( d ( t ) , {u}_{t + H}^{t + 1} ) . \qquad ( 17 )$$

As can be seen from the above minimization function (17), the CMPC module 24 minimizes the primary control objective based on the user-supplied allowable constraints violation risk increase parameter “ε”. Because the risk value upper constraint “u” is above the achievable value, optimization of the constraint “u” is thus always feasible.

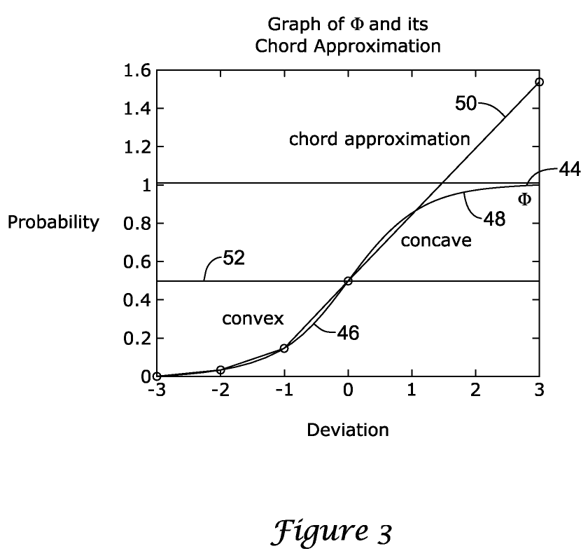

In some embodiments, the risk function “R” to be solved in equation (15) above can be determined by minimizing the convex envelope of the equation (15) using a chord approximation function. As further shown in FIG. 3, the standard probability function “Φ” for the solution of the risk function “R” can be represented graphically by curve 44, which includes both a convex half 46 below 0.5 or 50% probability and a concave or non-convex half 48 above 0.5. Since the convex half 46 can be numerically minimized via a linear programming algorithm, as discussed in greater detail below, the constraints on “R” can be approximated by a set of linear constraints on the future controls. A chord approximation function in the following form can then be used to provide a chord approximation 50 for the non-convex half 48 of the optimization problem:

$$\begin{matrix}1 - Φ ( z ) = {max}_{k} ( 1 - {l}_{1} ( z ) , … , 1 - {l}_{n} ( z ) ) \\ Φ ( z ) = {max}_{k} ( {l}_{1} ( z ) , … , {l}_{n} ( z ) )\end{matrix} ; \qquad ( 18 )$$

where “l” are linear functions of the chord lines, “n” is the number of linear segments, and “z” are the transformations for the upper and lower constraints.

The chord approximation 50 can only approximate the convex half 46 of the standard probability function “Φ” below line 52 in FIG. 3, and thus only values of below 0.5 are typically approximated via expression (18) above. As such, the chord approximation function is the convex envelope of the standard probability function “Φ”, which can be expressed generally as:

C(z)=conv{1−Φ(z)}, C̅(z)=conv{Φ(z)}; (19)

where “C(z)” represents the lower constraint related envelope, and where “ C̅(z)” represents the upper constraint related envelope.

Using the convex approximation by equating the convex envelopes in (19) above with the standard probability function “Φ”, the risk function “R” in (15) above can then be expressed as follows:

$$R ( d ( t ) , {u}_{t + H}^{t + 1} ) = {\sum }_{m = 1}^{H} ( {\sum }_{i} {\underline{w}}_{i} {max}_{k} \{ 1 - {l}_{k} ( {\underline{z}}_{i} ( t + m , d ( t ) , {u}_{t + H}^{t + 1} ) ) \} + … + {\sum }_{j} {\underline{w}}_{j} {max}_{k} \{ {l}_{k} {\overline{z}}_{j} ( t + m , d ( t ) , {u}_{t + H}^{t + 1} ) ) \} ) , \qquad ( 20 )$$

which can then be re-expressed using auxiliary process variables (π) relating to the optimal violation probabilities, as follows:

$$R ( d ( t ) , {u}_{t + H}^{t + 1} ) = {min}_{ \underline{π} , \overline{π}} {\sum }_{m = 1}^{H} ( {\sum }_{i} {\underline{w}}_{i} {\underline{π}}_{i} ( t + m ) + {\sum }_{j} {\overline{w}}_{j} {\overline{π}}_{j} ( t + m ) ) \\ {\overline{π}}_{i} ( t + m ) \geq {max}_{k} \{ {l}_{k} ( \overline{z} ( t + m , d ( t ) , {u}_{t + H}^{t + 1} ) ) \} \\ {\underline{π}}_{i} ( t + m ) \geq {max}_{k} \{ 1 - {l}_{k} ( \underline{z} ( t + m , d ( t ) , {u}_{t + H}^{t + 1} ) ) \} \qquad ( 21 )$$

The minimum achievable risk value “R*”can then be found via a linear programming technique, yielding the optimal future controls “u” that leads to the risk minimization. In some embodiments, solution of the future controls “u” can be determined by solving the following linear programming routine:

$$\{ \begin{matrix} {R}^{*} ( d ( t ) ) = {min}_{ \underline{π} , \overline{π} , u} {\sum }_{m = 1}^{H} ( {\sum }_{i} {\underline{w}}_{i} {\underline{π}}_{i} ( t + m ) + {\sum }_{j} {\overline{w}}_{j} {\overline{π}}_{j} ( t + m ) ) \\ {∀}_{k} {\overline{π}}_{j} ( t + m ) \geq {l}_{k} ( \overline{z} ( t + m , d ( t ) , {u}_{t + H}^{t + 1} ) ) \\ {∀}_{k} {\underline{π}}_{i} ( t + m ) \geq 1 - {l}_{k} ( \underline{z} ( t + m , d ( t ) , {u}_{t + H}^{t + 1} ) ) \\ {A}_{u} {u}_{t + H}^{t + 1} \leq {b}_{u}\end{matrix} \qquad ( 22 )$$

In the above routine (22), the constraints are linear with respect to the auxiliary process variables and with respect to the linear function of the chord lines “l”. Both the upper “l” and lower “l” are linear functions of “z” by virtue of the chord approximation defined in function (19) above. The “z” variables, in turn, are also linear with respect to the future process outputs by virtue of equation (12) above. In addition, the future process output predictions “y” are linear with respect to the future controls “u” since the process model is linear. Consequently, at time “t”, the linear programming problem data can be evaluated numerically and put into a standard form provided the initial condition “d(t)” is known and the future expected outputs can be expressed as linear functions of the future controls “u” by means of a predictor of the process model.

Once a linear programming algorithm is used to evaluate the minimum risk value “R*”, a second optimization algorithm employing quadratic programming can then be used to optimize the cautious process controls “u(t+1)”, which can be solved numerically based on the following quadratic programming routine:

$$\{ \begin{matrix} {u}_{t + H}^{t + 1} = arg {min}_{u} {J}_{x} ( d ( t ) , {u}_{t + H}^{t + 1} ) \\ {R}^{*} ( d ( t ) ) ( 1 + ɛ ) \geq {\sum }_{m = 1}^{H} ( {\sum }_{i} {\underline{w}}_{i} {\underline{π}}_{i} ( t + m ) + {\sum }_{j} {\overline{w}}_{j} {\overline{π}}_{j} ( t + m ) ) \\ {∀}_{k} {\overline{π}}_{j} ( t + m ) \geq {l}_{k} ( \overline{z} ( t + m , d ( t ) , {u}_{t + H}^{t + 1} ) ) \\ {∀}_{k} {\underline{π}}_{i} ( t + m ) \geq 1 - {l}_{k} ( \underline{z} ( t + m , d ( t ) , {u}_{t + H}^{t + 1} ) ) \\ {A}_{u} {u}_{t + H}^{t + 1} \leq {b}_{u}\end{matrix} \qquad ( 23 )$$

The above quadratic programming routine (23) thus yields the cautiously optimized controls “u(t+1)”, which can be applied to the process at the next sampling period. Such technique can then be repeated for each sampling period to optimally balance the primary control objective with the risk of a constraint violation.

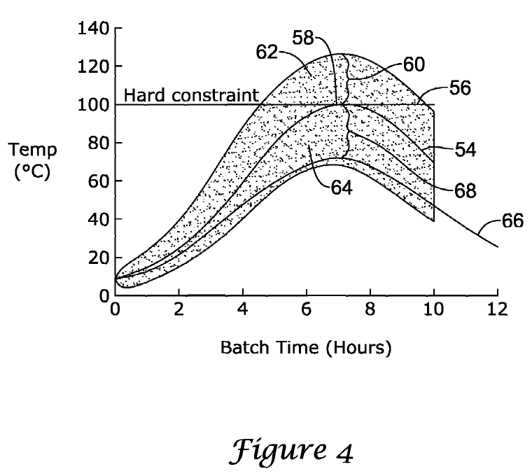

FIG. 4 is a graph showing an illustrative control solution for a cooling system using both the CMPC module 24 of FIG. 1 and a conventional MPC-based controller employing hard constraints. FIG. 4 may represent, for example, an illustrative attempt at controlling the temperature of an exothermic chemical process for a cooling system employed within a batch chemical reactor where the reactor cooling capacity is a limitation. In such case, model-predictive control is typically sought to minimize the batch time under the constraints of the reactor that would be suitable for producing the batch.

For such system, and as illustrated in FIG. 4, a conventional MPC-based solution may be represented generally by curve 54, which is subject to an imposed hard constraint represented generally by line 56. In a conventional approach, the MPC controller would typically attempt to maximize the cooling capacity at around 100% at point 58, where the hard constraint line 56 intersects with the solution curve 54. The polymerization time of the process in such case would thus follow this solution curve 54, which in an open loop system, would lead to a 50% probability of a constraint violation above the imposed hard constrain line 56, as indicated generally by bracket 60. The conventional MPC solution thus neglects the future prediction uncertainty in the solution, and does not discriminate between whether the actual peak cooling capacity will be above or below the maximum cooling allowed. The uncertainty from this technique, shown by the shaded areas 62,64 above and below the hard constraint line 56, thus represents the confidence region of a control system employing conventional model predictive control techniques.

In contrast to the conventional MPC solution curve 54, the solution provided by the CMPC module 24 would typically follow a separate solution curve 66 that is offset a distance 68 below the solution curve 54 followed by the conventional MPC controller. This cautious trajectory offset 68, which is below the maximum cooling hard constraint line 56 followed by the conventional MPC solution curve 54, thus represents a safety margin that the CMPC module 24 follows such that the probability of a constraint violation is at or near zero. The CMPC module 24 thus replaces the hard process constraints and/or slack variables used by conventional MPC controllers with a risk minimization function that provides a built-in safety margin for preventing constraint violations.

Because it is difficult to know in advance whether, and to what extent, a constraint violation is likely to occur for the solution curve 68 followed by the CMPC module 24, such built in safety margin will likely change depending on the controller parameters as well as other factors. In those instances where the process uncertainty can change in time, the CMPC module 24 can be configured to react by appropriately increasing the safety margin levels, allowing the CMPC module 24 to control multiple constrained volatile processes that are uncertain. Such adaptability can occur, for example, during fast, dynamic transients when the prediction uncertainty increases, causing the CMPC module 24 to temporarily decrease process efficiency in favor of greater process safety.

An example of such adaptation can be understood in the context of the above-described chemical reactor example. Generally speaking, the polymerization speed of the process can be severely affected by the purity of the reactant used. In some cases, the cooling system capacity may be insufficient, causing the batch product to spoil and, in some cases, lead to damage of the reactor. Counterbalanced with these considerations is the desire to complete polymerization as quickly as possible to maximize throughput of the plant. In such example, the process constraints and the process efficiency maximization may conflict with each other. The constraint violation typically occurs under these circumstances when there is a sudden change in the purity of the reactant, representing an unknown or disturbance variable of the process.

By stochastically determining the likelihood of a constraint violation and then offsetting the optimization solution based on this risk, the CMPC module 24 may then balance polymerization time with the heat demand on the cooling system in order to prevent the cooling system from overloading due to excessive demand. At the beginning of the batch, when the reactant purity grade is uncertain, the process can be controlled cautiously so that the probability of the cooling system overloading is small. As the polymerization process develops over time, however, the overall effect of the reactant grade uncertainty to the net heat production diminishes as the reactant consistency stabilizes, causing the CMPC module 24 to become less cautious. As such, the CMPC module 24 is thus capable of compensating for reactant purity as a random function of time, anticipating future parameter changes and transients that can cause system instability.

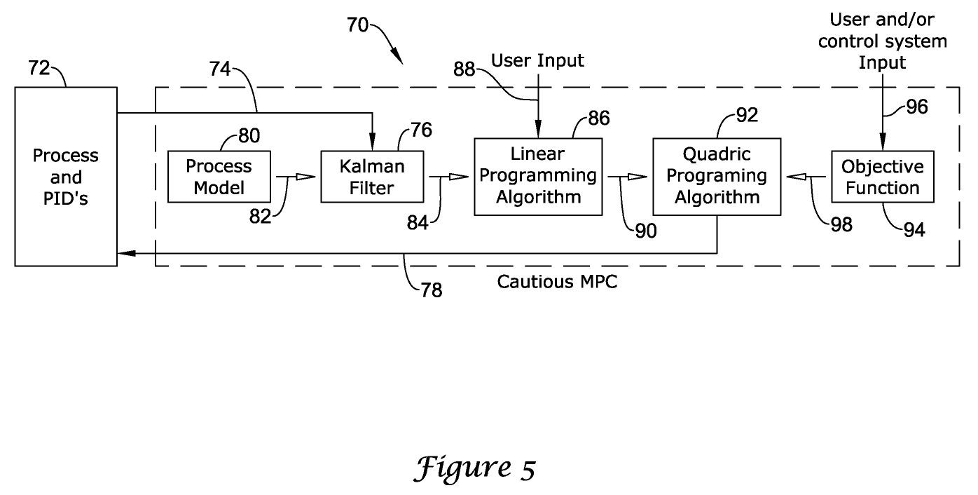

Referring now to FIG. 5, a block diagram of an illustrative method of cautiously controlling a process using a cautious MPC controller such as that described above with respect to FIG. 1 will now be described. The method, represented generally by arrow 70 in FIG. 5, may begin generally at box 72, in which the controlled process and measured variables used by the CMPC module and/or PID controllers are fed 74 to a predictor 76 such as a Kalman filter or the like, and one or more manipulated variables used by the CMPC module and/or PID controllers for control are returned 78 as optimized values. The steps of passing measured variables to the predictor 76 and receiving one or more manipulated variables back may occur, for example, within a single sampling period on the control horizon.

The process model to be controlled, represented generally by box 80, may contain those model parameters to be passed to the predictor 76. In some embodiments, for example, the model parameters may contain those parameters from a linear, sampled, time-invariant process model. These modeled parameters are then fed 82 to the predictor 76, which then computes the future expectations and variances. As indicated generally by arrow 84, the predictive parameters determined by the predictor 76 are then passed to a linear programming algorithm 86 for evaluating the minimum risk achievable on the control horizon starting from the actual process state. In some embodiments, for example, the linear programming algorithm 86 employed by the CMPC module can be configured to minimize the risk function based on user supplied input, as indicated generally by arrow 88. Such input 88 may include, for example, the upper and lower variable limits, the risk positive weights (i.e. “w”), and the maximum allowable risk increase parameter (i.e. “ε”) described above.

Once the minimum risk achievable on the control horizon is determined by the linear programming algorithm 86, the result can be passed 90 to a quadrature programming algorithm 92, which minimizes a primary control objective function 94. The objective function 94 can be configured to receive inputs 96 from a user and/or another control system, which creates data for the quadratic programming algorithm 92. The user-supplied inputs 96, for example, may represent the auxiliary process variables (i.e. π) relating to the optimal violation probabilities described above with respect to the optimization routine in (21) above. These additional constraints can be passed 98 to the quadratic programming algorithm 92, which, in addition to the constraints passed 90 from the linear programming algorithm 86, can be used to adjust the cautiousness of the model predictive control. The optimized solution provided by the quadratic programming algorithm 92 can then be fed back to box 72, as shown by arrow 78.

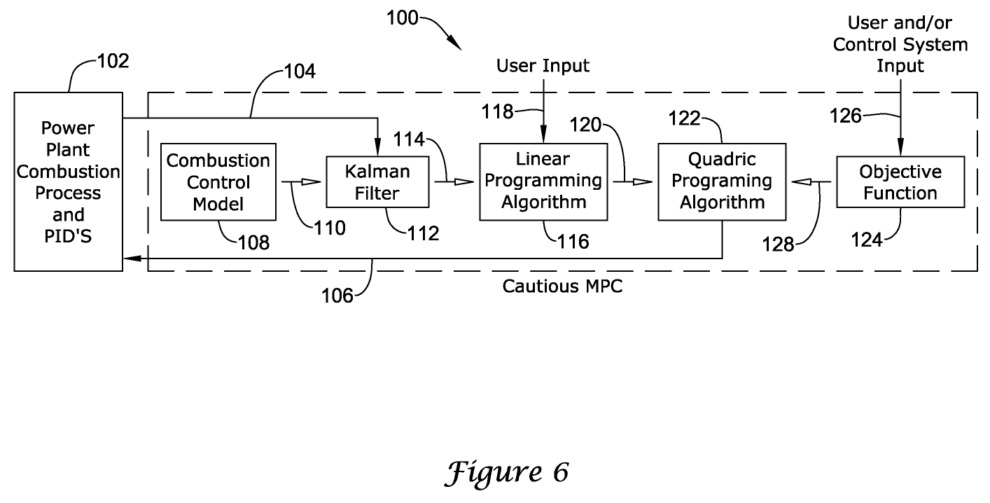

FIG. 6 is a block diagram showing an illustrative method 100 of cautiously controlling coal powder combustion in a power and heat plant boiler using a cautious MPC controller. As shown in FIG. 6, the power plant combustion process and associated PID controllers can be represented generally by box 102, which can be configured to output 104 the process variables, as indicated generally by arrow 104, and receive manipulated variables, as indicated generally by arrow 106. The process variables for the combustion process may include, for example, a fuel supply rate used by a master pressure controller to adjust the fuel supply rate for steam demand changes, and an air supply rate used by an air controller to adjust the air supplied to the boiler in order to stabilize excess air. The manipulated variables for the combustion process, in turn, can include the air and mass flow rates supplied to the coal burner. Other process and manipulated variables are possible, depending on the application.

In some conventional MPC techniques, the control system adjusts the air supply rate in proportion to the fuel supply using proportional-integral (PI) control with the oxygen concentration in the flue gases as feedback. In such a system, carbon monoxide (CO) may be generated if the excess air supplied to the boiler is too low. In some cases, if the excess air is under a certain low threshold value, the CO concentration within the boiler can increase very rapidly. The combustion efficiency maximum is thus usually close to this low threshold value of excess air. Because of the process uncertainty inherent in such control system due to the CO concentration, the oxygen concentration set point is often set high in order to maintain adequately low carbon monoxide (CO) levels, thus diminishing the overall boiler efficiency.

In the illustrative method depicted in FIG. 6, the combustion control model to be controlled, represented generally by box 108, can be configured to pass 110 the modeled parameters relating to the boiler to a predictor 112 such as a Kalman filter or the like, which can be configured to receive input 104 from the power plant combustion process 102 to compute the future expectations and variances. As indicated generally by arrow 114, the predictive parameters determined by the predictor 112 are then passed to a linear programming algorithm 116 for evaluating the minimum risk achievable on the control horizon staring from the actual process state. In a power plant combustion process, for example, the predictive parameters determined by the predictor 112 may represent the predictive variables used by the master pressure controller to adjust the fuel supply for steam demand changes, and the variables supplied to the boiler by the air controller used to adjust the air rate for stabilizing excess air. During this step, user-supplied inputs 118 relating to the optimal violation probabilities can be fed to the linear programming algorithm 116, which uses these probabilities to determine the cautiousness, or safety margin, that will be used in controlling the process. The user-supplied inputs 118, for example, may represent the auxiliary process variables relating to the optimal violation probabilities described above.

Once the minimum risk that the carbon monoxide (CO) generated is too high is determined by the linear programming algorithm 116, the result can be passed 120 to a quadratic programming algorithm 122, which seeks to maximize the combustion efficiency as a primary control objective function 124. As indicated generally by arrow 126, the combustion efficiency objective function 124 can be configured to receive inputs from a user and/or another control system, which creates data for the quadratic programming algorithm 122 that can be used to adjust the cautiousness of the model predictive control. Additionally controlled variables such as carbon monoxide (CO), oxygen, and oxides of nitrogen (NOₓ) concentrations can be further controlled, if desired. These additional constraints can be passed 128 to the quadratic programming algorithm 122, which, in addition to the constraints passed 120 to the linear programming algorithm 116, can be used to adjust the cautiousness of the model predictive control. The optimized solution provided by the quadratic programming algorithm 122 can then be fed back to box 102, as shown by arrow 106.

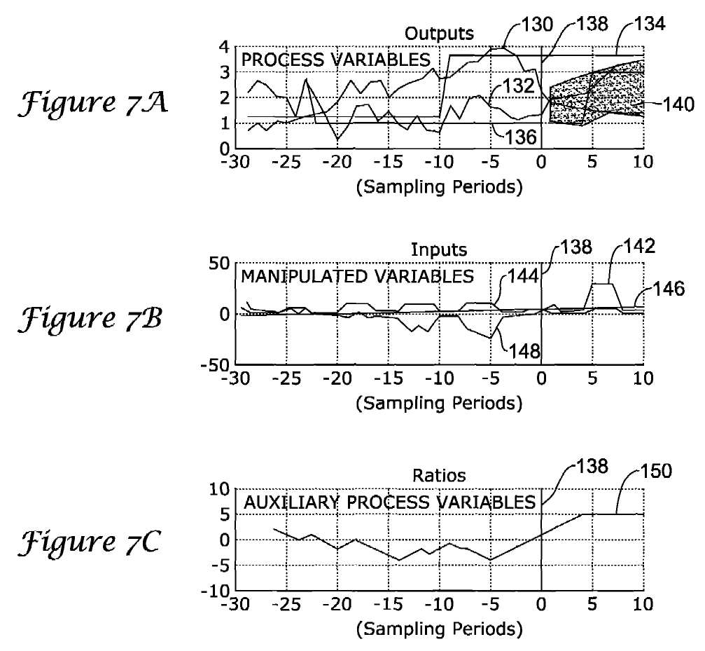

FIGS. 7A-7C are graphs representing several illustrative process variables, manipulated variables, and auxiliary process variables used in the illustrative combustion control problem of FIG. 6 over several sampling periods. As illustrated in a first graph in FIG. 7A, the process variables outputted can include a fuel supply rate parameter 130, an air supply rate parameter 132, and minimum and maximum constraint reference values 134,136, as shown. The vertical line 138 passing through time zero separates prior sampling periods (e.g. −5, −10, −15, etc.) from the future predictions (e.g. 5, 10, etc.). The controlled variable predictions for future sampling periods are depicted as shaded regions 140 in FIG. 7A, representing the confidence intervals for the control system.

In a second graph illustrated in FIG. 7B, the manipulated variables for each sampling period are further shown over the sampling period of FIG. 7A. As can be seen in FIG. 7B, the air to fuel ratio to be manipulated by the system is depicted generally by line 142. Other manipulated variables such as carbon monoxide (CO) concentration, oxygen concentration, and oxides of nitrogen (NOₓ) concentration are further depicted in FIG. 7B by lines 144, 146, and 148, respectively.

In a third graph illustrated in FIG. 7C, the auxiliary process variables used to adjust the cautiousness of the model predictive control is represented generally by line 150. As can be seen by comparing FIG. 7C with FIG. 7A, the auxiliary process variables 150 imposed on the outputted process variables 130,132 maintains the predicted control regions 140 within the minimum and maximum constraint reference values 134,136, relaxing the constraints when necessary. The value of the auxiliary process variables will often vary for each successive sampling period based on the ratios of the outputted process variables and the inputted manipulated variables.

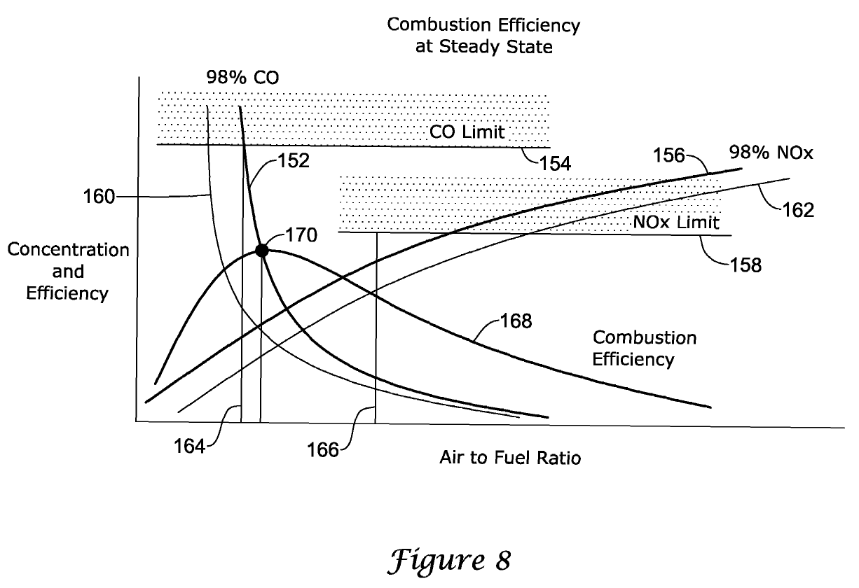

FIG. 8 is a graph showing the illustrative combustion control problem of FIG. 6 in a steady state condition. As can be seen in FIG. 8, line 152 represents a 98% confidence interval of the carbon monoxide (CO) concentration reaching an upper carbon monoxide limit 154 whereas line 156 represents a 98% confidence interval of the oxides of nitrogen (NOₓ) concentration reaching an upper NOₓ limit 158. Because of the many unmeasured disturbances possible in the control problem, the actual concentrations will tend to fluctuate from along mean CO and NOₓ curves, represented by lines 160 and 162, respectively.

Based on the air to fuel ratio as the manipulated variable, the cautious MPC controller seeks to determine the optimum air to fuel ratio that maximizes combustion efficiency while also obeying a lower constraint 164 and an upper constraint 166 imposed on the process. An illustrative trajectory of the combustion efficiency is depicted generally by curve 168, which has a maximum allowable combustion efficiency at point 170, as shown. While FIG. 8 shows the illustrative combustion control problem in steady state, it should be understood that the cautious MPC controller will typically determine dynamic transients of the concentrations and air and fuel supply rates, thus determining the entire trajectory of the air supply rate and not just the steady state air to fuel ratio, as illustrated by curve 168. Such dynamic control may occur, for example, when steady state operation of the combustion process is unlikely or is infeasible.

By employing cautious MPC control over the combustion control problem, the controller is able to optimize more than one manipulated variable simultaneously. For example, in addition to the primary air supply rate, the cautious MPC controller can also be configured to simultaneously optimize secondary and over-fire air supply rates as additional manipulated variables to the control problem. The cautious MPC controller can also better account for complex constraints on the manipulated variables such as rate limitations, box constraints and maximum/minimum constraint ratios, allowing optimization of both the steady state solution and dynamic transients.

Having thus described the several embodiments of the present invention, those of skill in the art will readily appreciate that other embodiments may be made and used which fall within the scope of the claims attached hereto. Numerous benefits of the invention covered by this document have been set forth in the foregoing description. It will be understood that this disclosure is, in many respects, only illustrative. Changes can be made with respect to various elements described herein without exceeding the scope of the invention.

What is claimed is:

1. A method of stochastically handling output limits of a control system using an MPC controller, the control system including a process model, a number of process variables and manipulated variables, and a number of constraints, the method comprising the steps of:
providing one or more modeled parameters and process variables to a predictor for predicting future expectations and variances along a control horizon of the control system;
stochastically determining the probability of a constraint violation of the constraints;
optimizing a control function of the control system to produce an optimized solution; and
offsetting the optimized solution based at least in part on the probability of a constraint violation.

2. The method of claim 1, wherein the step of stochastically determining the probability of a constraint violation of the constraints includes the step of minimizing a risk function.

3. The method of claim 2, wherein the risk function comprises the total risk associated with all constraints on the control horizon.

4. The method of claim 2, wherein the risk function is based at least in part on user-supplied input parameters.

5. The method of claim 2, wherein the risk function includes a chord approximation of a standard probability function.

6. The method of claim 2, wherein said step of minimizing the risk function is performed using a linear programming algorithm.

7. The method of claim 1, wherein said step of optimizing the control function and offsetting an optimized solution of the control function includes the steps of:
receiving one or more auxiliary process variables from a user and/or other control system, said auxiliary process variables relating to the violation probabilities of a constraint violation; and
adjusting the amount of offset to the optimized solution based at least in part on said auxiliary process variables.

8. The method of claim 7, wherein said one or more auxiliary process variables includes weighting parameters for one or more constraints of the control system.

9. The method of claim 7, wherein said one or more auxiliary process variables includes a constraint violation risk increase parameter.

10. The method of claim 1, wherein said step of optimizing the control function is performed using a quadratic programming algorithm.

11. The method of claim 1, wherein said MPC controller is adapted to dynamically control multiple volatile processes of the control system.

12. The method of claim 1, wherein said control system is a hierarchical control system including two or more levels of system control.

13. The method of claim 12, wherein said MPC controller provides supervisory model predictive control over one or more lower levels of system control.

14. A method of stochastically handling output limits of a control system using an MPC controller, the control system including a process model, a number of process variables and manipulated variables, and a number of constrains, the method comprising the steps of:
providing one or more modeled parameters and process variables to a predictor for predicting future expectations and variances along a control horizon;
evaluating a minimum risk function achievable on the future expectations and variances along the control horizon, said minimum risk function adapted to minimize a control objective of the control system; and
optimizing the control function based at least in part on the minimum risk function and one or more auxiliary process variables.

15. An MPC controller for cautiously controlling a control system, the control system including a process model, a number of process variables and manipulated variables, and a number of constraints, the controller comprising:
a means for predicting future expectations and variances based on one or more parameters received from a process model of the control system;
a means for stochastically determining the probability of a constraint violation; and
a means for optimizing a control function of the control system and producing an optimized solution based at least in part on the probability of a constraint violation.

16. The MPC controller of claim 15, wherein said means for predicting future expectations includes a Kalman filter.

17. The MPC controller of claim 15, wherein said means for stochastically determining the probability of a constraint violation includes a linear programming algorithm adapted to minimize a risk function.

18. The MPC controller of claim 15, wherein said means for optimizing the control function includes a quadratic programming algorithm.

19. The MPC controller of claim 18, wherein said quadratic programming algorithm is adapted to offset the optimized solution based at least in part on one or more auxiliary process variables relating to the probability of a constraint violation.

20. The MPC controller of claim 15, wherein the MPC controller is adapted to dynamically control multiple volatile processes of the control system.
